(19) United States
(12) Patent Application Publication
(10) Pub. No.: US 2007/0057816 A1
(43) Pub. Date: Mar. 15, 2007

(54) Parking assist method and parking assist apparatus

(75) Inventors: Seiji Sakakibara, Nagoya-shi (JP); Tomoki Kubota, Okazaki-shi (JP); Toshihiro Mori, Okazaki-shi (JP); Hiroaki Sugiura, Okazaki-shi (JP)

Correspondence Address: BACON & THOMAS, PLLC, 625 SLATERS LANE, FOURTH FLOOR, ALEXANDRIA, VA, 22314, US

(73) Assignee: AISIN AW CO., LTD., Anjo-shi (JP)

(21) Appl. No.: 11/515,733

(22) Filed: Sep. 6, 2006

(30) Foreign Application Priority Data
Sep. 12, 2005 (JP) 2005-264275
Jul. 28, 2006 (JP) 2006-206974

(51) Int. Cl. G08G 1/14

(52) U.S. Cl. 340/932.2

(57) ABSTRACT

A navigation apparatus includes a controller, an image data input unit adapted to acquire image data from a camera installed in a vehicle, and an image memory for storing the image data. The navigation apparatus also includes an image processing unit converting data extracted from the acquired image data to data simulating a virtual viewpoint. The image processing unit stores the converted data in the image memory in associated with position data indicating the position at which the image was taken by the camera. Using a plurality of sets of converted data, the image processing unit generates bird's eye view data representing a bird's-eye image of an area nearby the current vehicle position. When the controller determines that parking operation is stopped, the image processing unit displays the bird's eye view image together with a mark indicating the current vehicle position.

### INCORPORATION BY REFERENCE

The disclosure of Japanese Patent Application No. 2005-264275 filed on Sep. 12, 2005 and Japanese Patent Application No. 2006-206974 filed on Jul. 28, 2006, including the specification, drawings and abstract thereof, is incorporated herein by reference in its entirety.

### BACKGROUND OF THE INVENTION

1. Field of the Invention

The present invention relates to a parking assist method and a parking assist apparatus.

2. Description of the Related Art

An apparatus is known which assists a driver to park a vehicle by acquiring image data from an in-vehicle camera installed on the rear of the vehicle and providing a display according to the acquired image data on a monitor screen installed near the driver's seat. The in-vehicle camera is adapted to capture an image of an area behind the rear bumper of the vehicle, as seen looking rearward from the vehicle. However, the region below the floor of the vehicle cannot be captured by the camera, causing a problem in that, as the vehicle is approaching a target parking space, white lines delineating the target parking space are not included in the image captured by the camera, and it becomes difficult for the driver to determine the relative distance between the vehicle and the target parking space or the relative distance between the vehicle and the proper vehicle parking (stop) position. This makes it difficult for the driver to correctly park.

To solve the above problem, it has been proposed to store image data acquired from the in-vehicle camera in a memory and combine the image data stored in the memory with the current image data (see, for example, Japanese Unexamined Patent Application Publication No. 2001-218197and Japanese Unexamined Patent Application Publication No. 2002-354467). The composite image generated according to this technique includes an area which would otherwise be a blind spot, and thus allows the driver to know the relative position of the vehicle with respect to the target parking space. This composite image is displayed on the display monitor as the vehicle is moving backward.

Some drivers pay great attention to positions of obstacles and/or other vehicles adjacent the target parking space in the process of parking, and determine whether the vehicle has stopped at a correct final parking position. For well-skilled drivers or when there are no obstacles, it is unnecessary to display the composite image as the vehicle is moving backward. Thus, it is necessary to display the composite image in a manner adapted to the situation in which parking is performed or in a manner adapted to the skill of the driver.

### SUMMARY OF THE INVENTION

In view of the above deficiencies in the prior art, it is an object of the present invention to provide a parking assist method and a parking assist apparatus capable of outputting, at the proper time, an image including an area which would otherwise be a blind spot.

To achieve the above object, the present invention provides a method of assisting in parking using image data storage means for storing image data acquired from a camera unit installed in a vehicle, image processing means for executing image processing of the image data, and display means for displaying an image in accordance with the image data, the method comprising the steps of generating bird's eye view data representing an image of an area around a current vehicle position, the image being in the form of a bird's-eye view, i.e. as viewed from above the vehicle, based on the image data stored in the image data storage means, and displaying that image within the vehicle. The displayed image is a composite of the bird's eye view data and a vehicle mark indicating the current vehicle position.

The present invention also provides a parking assist apparatus installed in a vehicle, comprising vehicle status determination means for determining whether the vehicle parking operation has been stopped, based on input vehicle information, image data acquisition means for acquiring image data from a camera unit installed in the vehicle, first image processing means for generating converted data by image processing of the acquired image data, image data storage means for storing the converted data, second image processing means for generating bird's eye view data, representing an image of an area around the current vehicle position, based on the converted data stored in the image data storage means, and image output means for, responsive to a determination that the vehicle parking operation has been stopped, displaying the bird's eye view, and a vehicle mark indicating the current vehicle position superimposed thereon, as a composite image on the display means.

The present invention also provides a parking assist apparatus installed in a vehicle, comprising vehicle status determination means for determining whether the vehicle parking operation has been stopped, based on input of vehicle information, image data acquisition means for acquiring image data from a camera unit installed in the vehicle, image data storage means for storing the acquired image data, first image processing means for generating converted data by image processing of the acquired image data, second image processing means for generating bird's eye view data, representing an image of an area around the current vehicle position, based on the converted data, and image output means for, responsive to a determination that the vehicle parking operation has been stopped, displaying the bird's eye view, and a vehicle mark indicating the current vehicle position superimposed thereon, as a composite image on the display means.

In this parking assist apparatus, the image output means may output the bird's eye view data in a manner such that the area to the front side, as viewed forward of the vehicle, is displayed at the top of a display screen (display means).

The vehicle status determination means may determine, when the direction in which the vehicle is moving is changed from a direction toward a target parking space, that the vehicle parking operation has been stopped.

Alternatively, the vehicle status determination means may determine, when the vehicle has been stopped for a time longer than a predetermined time, that the vehicle parking operation has been stopped.

The second image processing means may combine the converted data such that the converted data corresponds to areas successively located side by side in a direction corresponding to the direction of movement of the vehicle.

The second image processing means may generate bird's eye view data representing an image of an area completely surrounding the vehicle, using a plurality of sets of converted data respectively derived from plural images captured by the camera unit.

The first image processing means may convert extracted data for an area of the road surface so as to represent an image of that area of the road surface as viewed from a virtual point vertically above that area of the road surface.

The second image processing means may generate the bird's eye view data using both current-position image data acquired at the current vehicle position and the stored converted data.

The image data storage means may attach, to the converted data or the image data, direction data indicating the direction or rudder angle data indicating the rudder angle as of the time at which the converted data or the image data was generated, and the image processing means may rotate the converted data or the image data in accordance with the attached direction data or rudder angle data and the direction or the rudder angle of the vehicle at the time when the parking operation is stopped.

The first image processing means may extract a middle area, as viewed in the travel direction of the vehicle, from the image data.

The image data acquisition means may acquire the image data from the camera unit and store the acquired image data in the image data storage means each time the vehicle reaches one of plural positions specified in advance as positions at which image data is to be captured.

The present invention provides also provides a parking assist apparatus installed in a vehicle, comprising vehicle status determination means for determining whether the vehicle parking operation has been stopped, based on input of vehicle information, image data acquisition means for acquiring image data from a camera unit installed in the vehicle, first image processing means for generating converted data by image processing of the image data, image data storage means for storing the converted data, composite data generation means for generating composite data including data representing an image of a rear end portion of the vehicle in combination with an image of a nearby area behind the vehicle, using (1) current-position image data acquired at the current vehicle position and (2) converted data which is stored in the image data storage means and which represents an image of an area in a current blind spot of the camera unit, second image processing means for generating, using the converted data stored in the image data storage means, bird's eye view data which represents a bird's-eye view image of an area completely surrounding the vehicle at the present position, a minor portion of which includes the current-position image data (1) and a major portion of which includes the converted image data (2), both included in the composite data, and image output means for, responsive to a determination that the vehicle parking operation has been stopped, outputting an image based on the composite data for display on the display means, i.e. a bird's eye view image including an image of the whole vehicle based on the bird's eye view data and a vehicle mark indicating the current vehicle position.

The present invention provides also provides a parking assist apparatus installed in a vehicle, comprising vehicle status determination means for determining whether the vehicle parking operation has bene stopped, based on input of vehicle information, image data acquisition means for acquiring image data from a camera unit installed in the vehicle, first image processing means for generating converted data by image processing of the image data, image data storage means for storing the converted data, composite data generation means for generating composite data including (1) data representing an image of a rear portion of the vehicle in combination with (2) an image of a nearby area behind the vehicle based on a combination of the current-position image data acquired at the current vehicle position and the converted data which is stored in the image data storage means and which represents an image of an area in a current blind spot of the camera unit, second image processing means for generating, using the converted data stored in the image data storage means, bird's eye view data which represents a bird's-eye view image of an area completely surrounding the vehicle at the present position, and which includes a smaller percentage of the current-position image data than does the composite data, and moving body detection means for detecting a moving body in an area nearby the current vehicle position, image output means for, responsive to a determination that the vehicle parking operation has been stopped, outputting a bird's eye view image including an image of the whole vehicle, based on the bird's eye view data together with a vehicle mark indicating the current vehicle position, to the display means for displaying the bird's eye view image, and image switching means for, responsive to detection of a moving body, switching the displayed image from the image based on the bird's eye view data and the vehicle mark to an image based on the composite image data.

The present invention also provides a parking assist apparatus installed in a vehicle, comprising vehicle status determination means for determining whether the vehicle parking operation has been stopped, based on vehicle information input to the vehicle status determination means, image data acquisition means for acquiring image data from a camera unit installed in the vehicle, first image processing means for generating converted data by image processing of the image data, image data storage means for storing the converted data, output data generation means for generating image output data representing an image of an area in a current blind spot of the camera unit, using at least one of the converted data stored in the image data storage means and current-position image data acquired at the current vehicle position, and image output means for outputting the output data to display means for displaying an image based on the image output data, wherein, responsive to a determination made by the vehicle status determination means that the vehicle parking operation has been stopped, the output data generation means generates image output data representing a bird's eye view image including an image of the whole vehicle, and, responsive to a determination by the vehicle status determination means that the vehicle parking operation has not been stopped, the output data generation means generates image output data including a greater percentage of the current-position image data than is included in the image output data which is generated when the vehicle parking operation has been stopped.

The present invention provides the advantage that, when parking operation has been stopped, bird's eye view data representing a bird's eye image of an area nearby the vehicle and a mark indicating the current vehicle position are displayed on the display means, which display allows the driver to determine whether the vehicle is correctly positioned and oriented in a correct direction for parking in the target parking space. When it is necessary to adjust the parking operation, the displayed image allows the driver to know the extent of deviation of the current vehicle position from the correct parking position.

In the parking assist apparatus, using image data or converted image data captured at various vehicle positions during the parking operation and stored in the image data storage means, bird's eye view data representing a bird's eye image of an area nearby the vehicle and a mark indicating the current vehicle position are displayed on the display means when the parking operation is stopped. This makes it possible to display an image that allows the driver to determine whether the vehicle is correctly positioned and oriented in the target parking space at the completion of the parking operation. When it is necessary to redo the parking operation, the displayed image allows the driver to know the extent of deviation of the current vehicle position from the correct parking position.

In the parking assist apparatus, the image output means outputs the bird's eye view data for an area to the front, as viewed in the forward direction of the vehicle, displayed in an area at the top of a screen of the display means so that the driver can easily and correctly understand the direction of the bird's eye view displayed on the display means.

In the parking assist apparatus, when the direction of travel of the vehicle is changed from the current direction, it is determined that the parking operation has been stopped, and the bird's eye view data is displayed. The displayed bird's eye view is useful for the driver either to confirm that the vehicle is properly positioned or to redo the parking operation if the vehicle position is not correct.

In the parking assist apparatus, when the vehicle has been stopped for a time longer than the predetermined period, in this case also it is determined that the parking operation has been stopped, and the bird's eye view is displayed.

In the parking assist apparatus, the bird's eye view data is generated by placing a plurality of sets of converted data, corresponding to side by side images, and extending in a direction corresponding to the travel direction of the vehicle. That is, converted data for a plurality of successive images captured at successive vehicle positions during the movement of the vehicle toward the target parking space are combined into a single composite image. This makes it possible to obtain the composite image via a simple process.

In the parking assist apparatus, an image of an area covering the whole vehicle can be displayed on the display means which allows the driver to easily and correctly understand the relative position of the vehicle as a whole with respect to the target parking space.

In the parking assist apparatus, image data or an extracted portion of the image data is converted so as to represent an area of a road surface as viewed from a virtual viewpoint vertically above that area of the road. This makes it possible to display the bird's eye view in a manner that allows the driver to easily and correctly understand the displayed image.

Because the bird's eye view data is based on the current-position image data and the stored converted data, the displayed image correctly represents an area nearby the current vehicle position.

In the parking assist apparatus, the converted data or the image data are rotated in accordance with the direction or the rudder angle of the vehicle as of the time of stopping the parking operation. This makes it possible to display the bird's eye image with high precision.

In the parking assist apparatus, the bird's eye view data is generated from data extracted from a plurality of images. This makes it possible to generate an image with substantially no distortion by combining a plurality of small-area images, each extracted from larger area images having distortion in their peripheral areas due to the wide angle lens of the camera unit.

In the parking assist apparatus, image data is derived from images acquired at various vehicle positions during the movement of the vehicle toward the target parking space which makes it possible to generate the bird's eye view data using the data for a plurality of images captured during movement of the vehicle in reverse toward the target parking space.

When the vehicle parking operation is not stopped, as when the vehicle is moving in reverse toward a target parking space, composite data is output which represents an image of the rear end of the vehicle and a nearby area behind the vehicle including an area in the current blind spot of the camera unit. This makes it possible for the driver of the vehicle to perform the parking operation while viewing an image of white lines or the like displayed on the screen to determine whether the vehicle is correctly moving toward a target parking space. Note that even white lines or the like in the current blind spot of the camera unit are also displayed on the screen. However, when the parking operation is stopped, the bird's-eye view image including the image of the whole vehicle are displayed on the display means based on the converted data stored in the image data storage means, thus allowing the driver to determine whether the vehicle is correctly positioned and oriented in the target parking space at the end of the parking operation.

As noted above, an area around the vehicle and the mark indicating the current vehicle position are displayed on the display means when the parking operation has been stopped. However, with the bird's eye view and the vehicle position mark displayed on the display means, if a moving body such as a pedestrian enters the area nearby the vehicle, a composite image including an image in the current blind spot of the camera unit and an image of the current view of the area nearby the vehicle is displayed. Thus, it is possible not only to display, at the appropriate time, a screen that allows for determining the vehicle position with respect to the target parking space, but it is also possible, when a moving body is detected in the area nearby the vehicle, to display a screen indicating the position of the moving body and calling the driver's attention to the moving body.

### BRIEF DESCRIPTION OF THE DRAWINGS

FIG. 1 is a block diagram of a navigation apparatus according to an embodiment of the present invention.

FIG. 2 is a schematic diagram of the rear of a vehicle showing a position at which a camera is installed.

FIG. 3 is a schematic diagram of a vehicle contour.

FIG. 4 shows a rear view monitor screen.

FIG. 5 is a schematic diagram showing the manner in which a vehicle moves in reverse into a target parking space.

FIG. 6A shows a vehicle positioned to initiate parking, FIG. 7B shows image data, FIG. 7C illustrates viewpoint conversion, FIG. 7D shows converted data, and FIG. 7E shows rotated data.

FIG. 7 shows the structure of converted data stored in an image memory.

FIG. 8 is a flow chart of an assist process according to an embodiment of the method of the present invention.

FIG. 9 is a flow chart showing a system start control subroutine of the assist process of FIG. 8.

FIG. 10 is a flow chart showing an image data input subroutine of the assist process of FIG. 8.

FIG. 11 is a flow chart showing a converted data generation subroutine of the assist process of FIG. 8.

FIG. 12 is a flow chart showing a bird's eye image display subroutine of the assist process of FIG. 8.

FIG. 13A shows a vehicle at position B, FIG. 13B shows image data, FIG. 13C illustrates viewpoint conversion, FIG. 13D shows converted data, and FIG. 13E shows rotated data.

FIG. 14 shows a bird's eye view.

FIG. 15 shows a parking position confirmation screen.

FIG. 16 shows another parking position confirmation screen.

FIG. 17 shows yet another example of a parking position confirmation screen.

FIG. 18 shows an example of structure of converted data.

FIG. 19 shows another example of a parking position confirmation screen.

FIG. 20 shows yet another example of a parking position confirmation screen.

FIG. 21(a) shows a map screen, and FIG. 21(b) shows another example of a parking position confirmation screen and a rear view monitor screen displayed together as a split screen.

### DESCRIPTION OF THE PREFERRED EMBODIMENTS

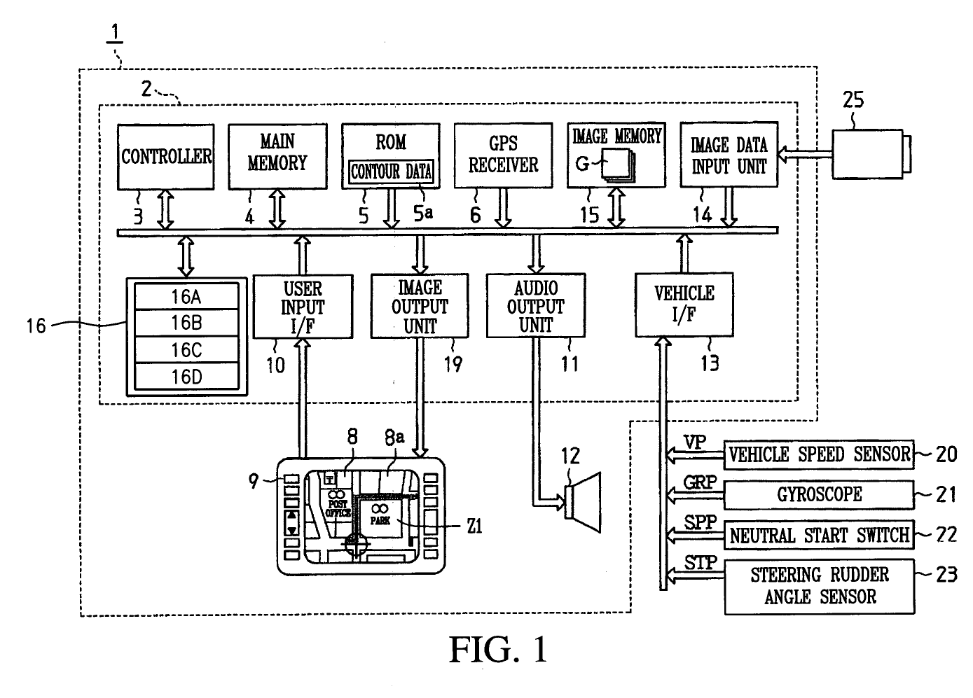

The parking assist method and the parking assist apparatus according to the present invention will now be described with reference to an on-board vehicle navigation apparatus embodying the present invention, with references to FIGS. 1 to 16.

As shown in FIG. 1, navigation apparatus 1 serves as a parking assist apparatus and includes a control unit 2. The control unit 2 includes a controller 3 serving as vehicle status determination means, a main memory 4, and a ROM 5. The controller 3 includes a CPU (not shown) and is mainly responsible for execution of each of various control processes in accordance with various programs such as a route guidance program, a parking assist program, etc. stored in the ROM. The main memory 4 is used to temporarily store results of routines executed by the controller 3, and also used to store various variables and flags used in the parking assist process.

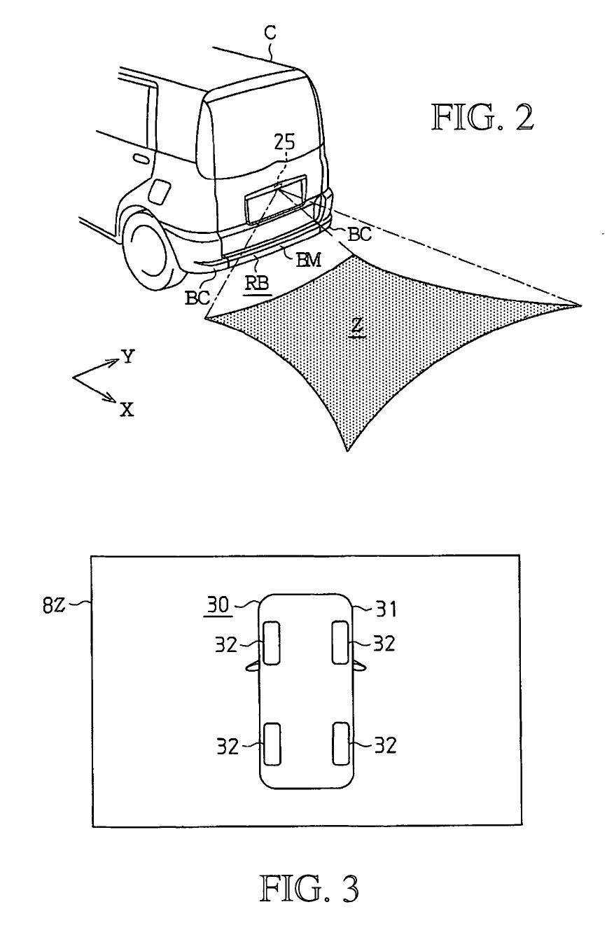

Contour data 5a is stored in the ROM 5. The contour data 5a is used to display the contour of the vehicle C (see FIG. 2) in which the navigation apparatus 1 is installed, on the display 8 serving as the display means. More specifically, a vehicle contour 30 such as that shown in FIG. 3 is displayed as a vehicle mark indicating the vehicle C on the display 8 in accordance with the contour data 5a. The vehicle contour 30 includes an outer contour 31 indicating the outer contour of the vehicle and a wheel contour 32 indicating the positions of front and rear wheels. The outer contour 31 is in accordance with the width and the length of the vehicle C and includes a representation of side view mirrors and a representation of the front or rear end of the vehicle C.

The control apparatus 2 also includes a GPS receiver 6 which receives radio signals transmitted from GPS satellites. The controller 3 periodically calculates the absolute position in latitude, longitude, and altitude of the vehicle C, based on the position detection signals input via the GPS receiver 6.

The navigation apparatus 1 also includes a display 8 with a touch panel (screen). When the vehicle C is traveling forward, the controller 3 reads map drawing data from a map data storage unit (not shown) and displays a map screen 8a as shown in FIG. 1. If a user touches the touch panel or operates a switch (button) 9 disposed on the display 8 at a location close to the display screen 8, a user input interface (I/F) 10 included in the control apparatus 2 outputs a signal corresponding to the input operation to the controller 3.

The control apparatus 2 also includes an audio output unit 11. The audio output unit 11 includes a memory (not shown) in which audio files are stored and also includes a digital-to-analog converter. Using an audio file, the audio output unit 11 outputs audio guidance (voice) or a warning sound from a speaker 12 included in the navigation apparatus 1.

The control apparatus 2 also includes a vehicle interface (I/F) 13. Via this vehicle interface 13, the controller 3 receives vehicle information such as a vehicle speed pulse VP and a direction detection signal GRP from a vehicle speed sensor 20 and a gyroscope 21 disposed in the vehicle C. The controller 3 analyzes the waveform of the vehicle speed pulse VP to determine whether the vehicle C is running forward or backward. The controller 3 also calculates a precise distance of movement of the vehicle C from a reference position based on the number of input pulses. Based on the input direction detection signal GRP, the controller 3 updates the current direction GR stored as a variable in the main memory 4. The controller 3 also calculates the relative position and the relative direction with respect to the reference position/direction by means of autonomous navigation using the vehicle speed pulse VP and the direction detection signal GRP, and, based on the calculated relative position and direction, the controller 3 corrects the current vehicle position calculated based on the signal output from the GPS receiver 6. In the present embodiment, the current vehicle position is defined by the position of a rear axle of the vehicle C, although another position may be used to define the current vehicle position.

Via the vehicle interface 13, the controller 3 receives a shift position signal SPP as vehicle information from a neutral start switch 22 of the vehicle C, and the controller 3 updates a variable indicating a shift position SP stored in the main memory 4 according to the received shift position signal SPP. The controller 3 also receives a steering sensor signal STP as vehicle information from a steering rudder angle sensor 23 via the vehicle interface 13. In accordance with the received steering sensor signal STP, the controller 3 updates a current rudder angle ST stored in the main memory 4.

The control apparatus 2 includes an image data input unit 14 serving as image data acquisition means. Under the control of the controller 3, the image data input unit 14 continuously acquires image data G by controlling a rear view monitor camera (hereinafter referred to simply as a camera) 25 installed as a camera unit in the vehicle C.

As shown in FIG. 2, the camera 25 is installed on a rear (hatch) door or the like on the rear end of the vehicle C such that the optical axis of the camera 25 is directed downward. The camera 25 is a color digital camera which has an optical system including a wide angle lens (not shown), a mirror, etc. and a CCD image sensor (not shown). The camera 25 has a horizontal field of view of, for example, 140 degrees and is set so as to take an image of a rear view in a range (Z) of a few meters including the rear end of the vehicle C. Under the control of the controller 3, the image data input unit 14 acquires image data G converted from analog form into digital form from the camera 25 and temporarily stores the acquired image data G in an image memory 15 (image data storage means) disposed in the control apparatus 2.

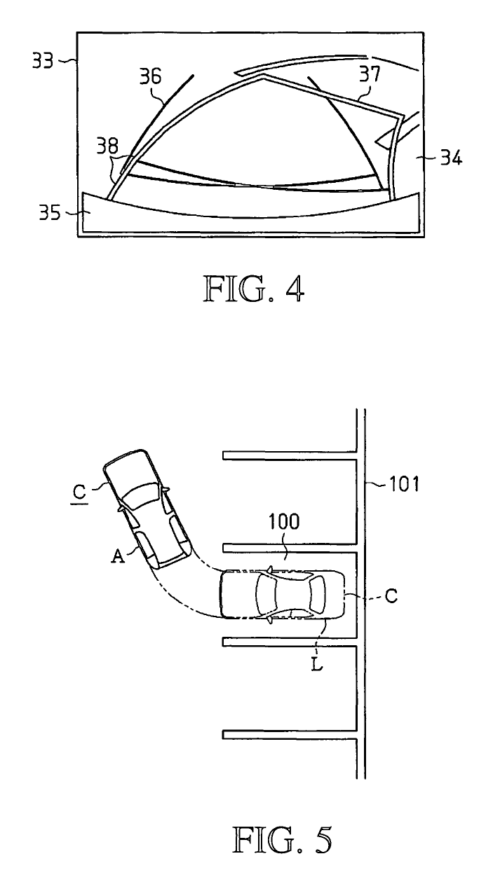

The control apparatus 2 includes an image processing unit 16 including first image processing means 16A, second image processing means 16B, composite data generating means 16C and image output means 16D, and also includes an image output unit 19 serving as another image output means. When the vehicle C is moving backward, the image processing unit 16 outputs the image data G temporarily stored in the image memory 15 to the display 8 for display of a rear view screen 33 as shown in FIG. 4. A rear view image 34 and a rear end image 35 are displayed on the rear view screen 33. The rear view image 34 is an image of a view as seen looking backward from the vehicle C. The rear view image 34 is displayed in a horizontally flipped form so that it looks like an image similar to an image in a rear view mirror. Because the rear view image 34 is taken by the camera 25 through a wide angle lens, the rear view image 34 has distortion in a peripheral area. The rear end image 35 is an image of a central part BM of a rear bumper RB of the vehicle C shown in FIG. 2, and does not include end portions BC of the rear bumper RB. The composite data generating means 16C combines the image 35 of rear end portion of the vehicle with the rear view image 34, combining (1) current-position image data acquired at the current vehicle position and (2) converted data stored in the image data storage means and which represents an image of an area in a current blind spot of the camera unit 25, for display of the rear view image 35.

The image processing unit 16 displays guide lines including vehicle width lines 36 and predicted locus lines 37 on the rear view screen 33. The vehicle width lines 36 are lines extending backward from the sides of the vehicle C and simply indicating the vehicle width C. The predicted locus lines 37 are lines indicating predicted locus lines along which the vehicle C will move backward. The predicted locus lines 37 are calculated within a predetermined range (for example, 2.7 m) from the end of the vehicle C, based on the vehicle width and the current rudder angle ST.

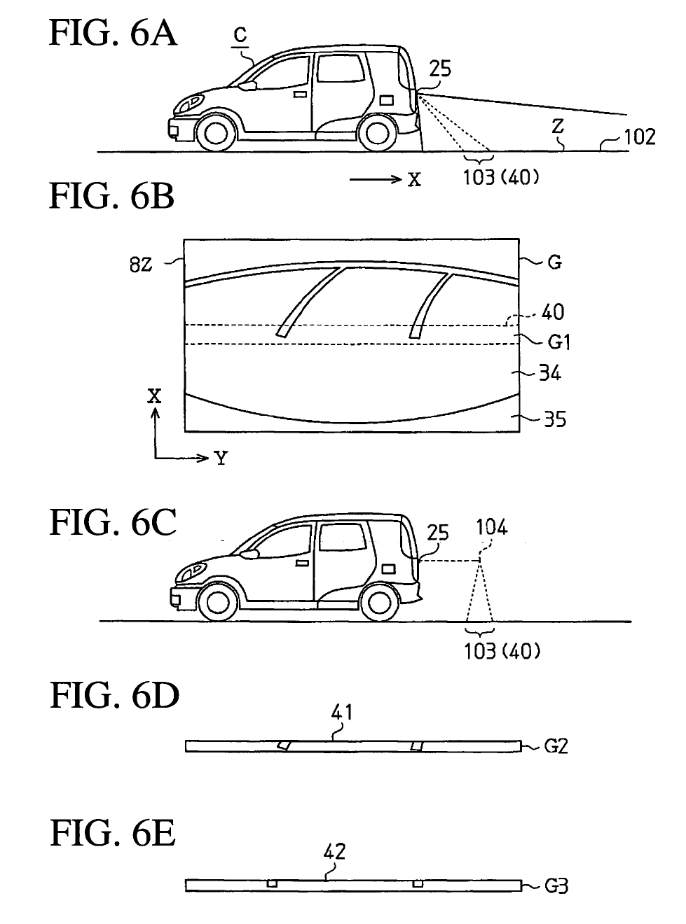

The image processing unit 16 executes a conversion process on image data G captured each time the vehicle C reaches one of the image taking points spaced apart by an image recording distance D1 (200 mm in the present embodiment), and stores the resultant converted image data in the image memory 15. More specifically, for example as shown in FIG. 5, when the vehicle is at an initial position A at which the vehicle C starts to move backward toward a target parking space 100, separated from adjacent areas by white lines 101, the image processing unit 16 acquires image data G via the image data input unit 14 under the control of the controller 3. The acquired image data G represents an image of a rear view 34 of a road surface 102, as viewed backward from the vehicle C, such as that shown in FIG. 6B, taken over an image capturing range Z as shown in FIG. 6A.

The image processing unit 16 extracts data, defined by an extraction area 40, from the image data G captured at the initial position A, thereby acquiring extracted data G1. The extraction area 40 is defined so as to have a width substantially equal to the width (as measured along the y axis direction in the screen coordinate system) of the display area 8z of the display 8 as shown in FIG. 6B. The height of the extraction area 40 is set to be equal to a width (as measured in the x direction) of a middle area, defined as the display area 8z, as viewed in the x direction corresponding to the direction of rearward movement of the vehicle C. Because the image data G in the extraction area 40 is image data for a road area relatively close to the vehicle C, the extracted data G1 can provide a clear image. Moreover, because the extraction area 40 is defined as a narrow zone in the middle of the original imaged area, there is little distortion due to the lens of the camera 25. As shown in FIG. 6A, the extraction area 40 corresponds to a particular zone 103 in the image taking area defined as an area Z of the road surface 102 in the vehicle coordinate system (X, Y). In the present embodiment, the width of this zone 103, as measured in the X direction, is set to be equal to 500 mm.

The image processing unit 16 generates converted data G2 by converting the extracted data G1 into data representing a viewpoint different from the original viewpoint of the extracted data G1. More specifically, as shown in FIG. 6C, a virtual viewpoint 104 is defined at a point vertically above a point in the middle of the above-described zone 103 of the road surface 102. The height of the virtual viewpoint 104 is set to be substantially equal to the height at which the camera 25 is installed. A middle portion of the extracted data G1 is subjected to a coordinate transformation so as to be converted into data representing a bird's eye image of the zone 103 as viewed from the virtual viewpoint 104.

More specifically, the coordinate transformation is performed by the image processing unit 16 by mapping pixel values of the extracted data G1 at respective pixel coordinates and converting the mapped coordinates according to a conversion table stored in the ROM 5. In this manner the extracted data G1 representing the image as viewed from the camera viewpoint at the initial position A is converted into data G2 representing the image as viewed from the virtual viewpoint 104. FIG. 6D shows a specific example of an image 41 represented by the converted data G2. The converted data G2 is generated from the middle portion of the extracted data G1 and corresponds to a zone with a width of about 200 mm of the road surface.

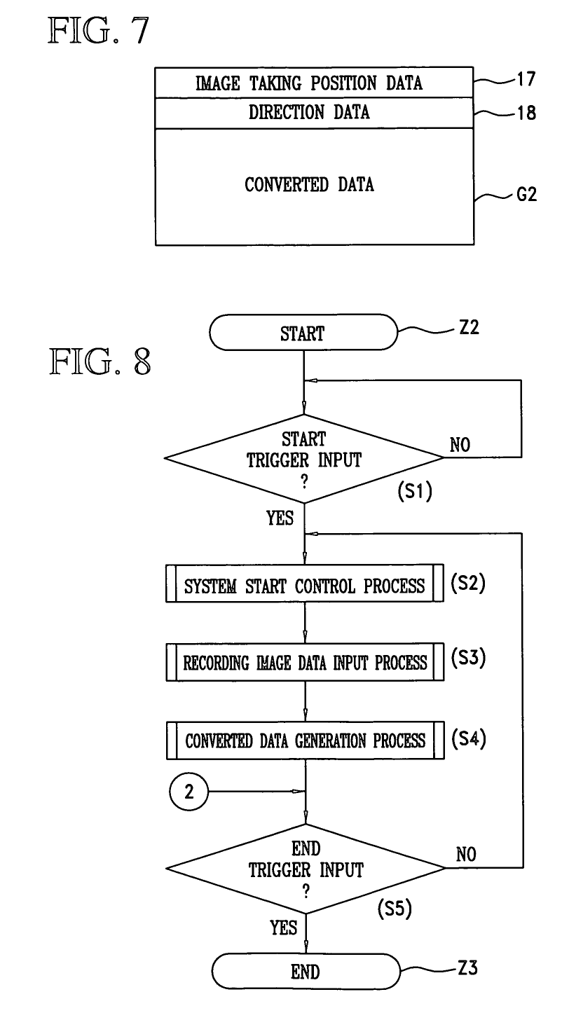

Thereafter, as shown in FIG. 7, under the control of the controller 3, the image processing unit 16 attaches, to the resultant converted data G2, image taking position data 17 indicating the position (the initial position A in this specific case) at which the image for original data G1 was captured, and direction data 18 indicating the direction as of when the original data G1 was captured (in this specific case, the direction GR indicated by the current direction data GR acquired at the initial position A), and the image processing unit 16 stores the total of the thus correlated data in the image memory 15.

Each time the vehicle C moves an image recording distance D1, converted data G2 is generated from image data G and stored in the above-described manner.

After at least as many sets of converted data G2 as specified (corresponding to 24 images in the present embodiment) have been stored in the image memory 15, if the controller 3 issues a composite data generation command, the image processing unit 16 combines the respective sets of converted data G2 and displays the resultant composite image on the display 8. More specifically, the image processing unit 16 supplies the composite data to the image output unit 19, which displays the supplied composite data as a composite image on the display 8.

Now a process which is executed when the vehicle C moves backward toward the target parking space 100, as shown in FIG. 5, will be described. Referring to the flow chart shown in FIG. 8, the controller 3 waits for a start trigger to be generated, which causes a parking assist program stored in the ROM 5 to be started (step S1). In the present embodiment, the start trigger is generated when an ignition switch is turned (or ignition module is started) or when the navigation apparatus 1 is turned on. If the start trigger is detected, then, under the control of the controller 3, a system start control subroutine (step S2), a recording image data input subroutine (step S3), and a converted data generation subroutine (step S4) are executed under the control of the controller 3. The controller 3 determines whether an end trigger has been generated (step S5). If the determination in step S5 is that the end trigger has not been generated, the routine returns to step S2. In the present embodiment, the end trigger is generated when the ignition module is turned off or when the navigation apparatus 1 is turned off.

System Start Control Subroutine

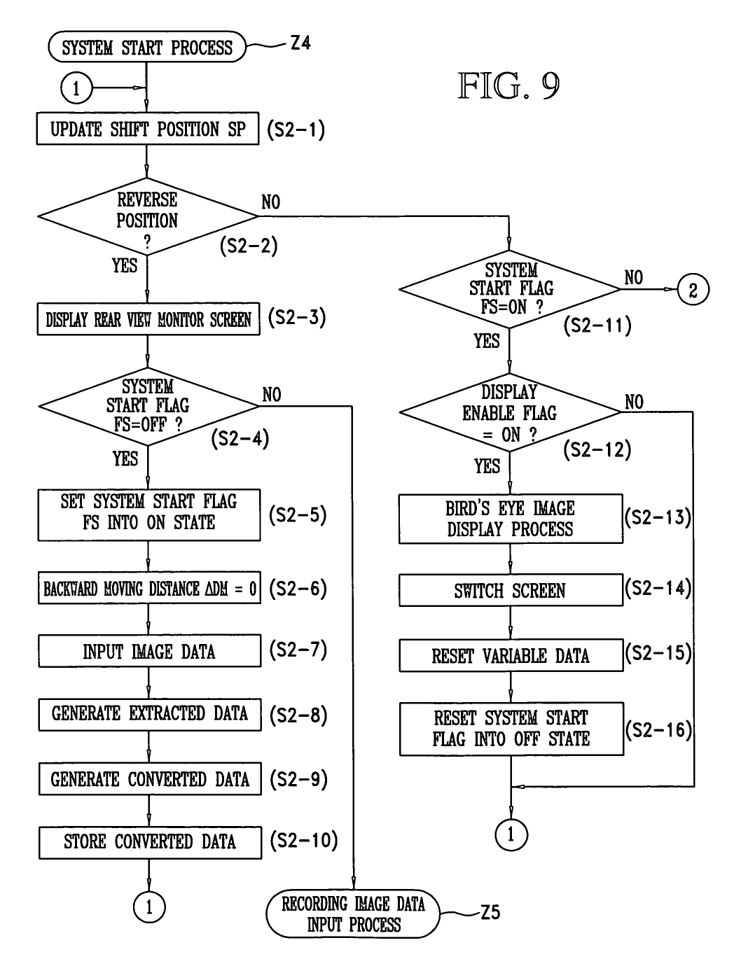

The system start control subroutine S2 is illustrated in FIG. 9. First, the controller 3 acquires a shift position signal SPP via the vehicle interface 13 and updates the shift position data SP indicating the shift position stored in the main memory 4 (step S2-1). The controller 3 determines whether the shift position SP is reverse (step S2-2) and whether the parking operation has been stopped. Herein, the “stopped” parking operation refers to a state in which the parking operation is completed or a state in which the movement of the vehicle C toward the target parking space 100 is stopped before the completion of parking for the purpose of starting the parking operation over again. More specifically, in the present embodiment, when the direction of movement of the vehicle C is changed from the direction in which the vehicle C is moving backward toward the target parking space 100, that is, when the shift position SP of the vehicle C is changed from the reverse position to any other shift position, it is determined that the parking operation has been stopped.

If the controller 3 determines in step S2-2 that the shift position SP is not at the reverse position but at another position, such as the drive position or the parking position (that is, the answer to step S2-2 is No), then the controller 3 further determines whether the system start flag FS is ON (step S2-11). The system start flag FS is a flag indicating whether the composition mode in which converted data G2 is generated is activated. Note that in the initial state (system start-up), the system start flag FS is set to be “0” (OFF state). If the system start flag FS is OFF, as is the case, for example, when the vehicle C is running forward (that is, if the answer to step S2-11 is No), the routine returns to step S5 to determine whether the end trigger has been received.

On the other hand, when the vehicle C is at the initial position A and the vehicle C has started to move backward toward the target parking space 100 as shown in FIG. 5, the shift position is the reverse position (the answer to step S2-2 is Yes). In this case, under the control of the controller 3, the image processing unit 16 acquires the image data G taken at the initial position A from the image data input unit 14 and supplies the acquired image data G to the display monitor 8 to display the rear view screen 33 on the display monitor 8 (step S2-3). While the vehicle C moves backward without stopping, the rear view screen 33 is displayed on the display monitor 8 and an image of a rear view of the nearby area behind the vehicle C is displayed on the rear view screen 33.

The controller 3 then determines whether the system start flag FS stored in the main memory 4 is ON (step S2-4). If the system start flag FS is OFF (that is, if the answer in step S2-4 is Yes), the composition mode has not yet been activated. In this case, the system start flag FS is set to ON (“1”) to activate the composition mode (step S2-5). The controller 3 then initializes the rearward moving distance ΔDM stored as a variable in the main memory 4 to “0” (step S2-6). Note that the rearward moving distance ΔDM is calculated, based on the vehicle speed pulse VP, to determine the distance the vehicle C has moved rearward from the reference position, and to determine the timing of generation of converted data G2 described above.

Under the control of the controller 3, the image processing unit 16 acquires the image data G taken when the vehicle C started movement in reverse, that is, the data G for the image captured at the initial position A, from the image data input unit 14 (step S2-7). The image processing unit 16 extracts the data for the extraction area 40 from the image data G acquired in step S2-7, thereby obtaining the extracted data G1 (step S2-8).

The image processing unit 16 then executes viewpoint conversion of the extracted data G1 to generate the converted data G2 for a view from the virtual viewpoint 104 (step S2-9)

The controller 3 acquires the direction detection signal GRP at the initial position A via the vehicle interface 13 and updates the current direction GR stored in the main memory 4 in accordance with the acquired direction detection signal GRP. The image capture position data 17 indicating that the converted data G2 is based on the image data for an image captured at the initial position A and the direction data 18 based on the current direction GR are attached to the converted data G2 obtained in step S2-9, and the total of the thus correlated data is stored in the image memory 15 (step S2-10). After the converted data G2 associated with the initial position A is stored, the process returns to step S2-1.

On the other hand, in the case where the determination in step S2-4 is that the system start flag FS is ON (that is, if the answer in step S2-4 is “No”), it is determined that the reverse movement of the vehicle C from the initial position A has already started and the vehicle is now moving in reverse toward the target parking space 100, and thus the process proceeds to the recording image input subroutine S3.

Recording Image Data Input Subroutine

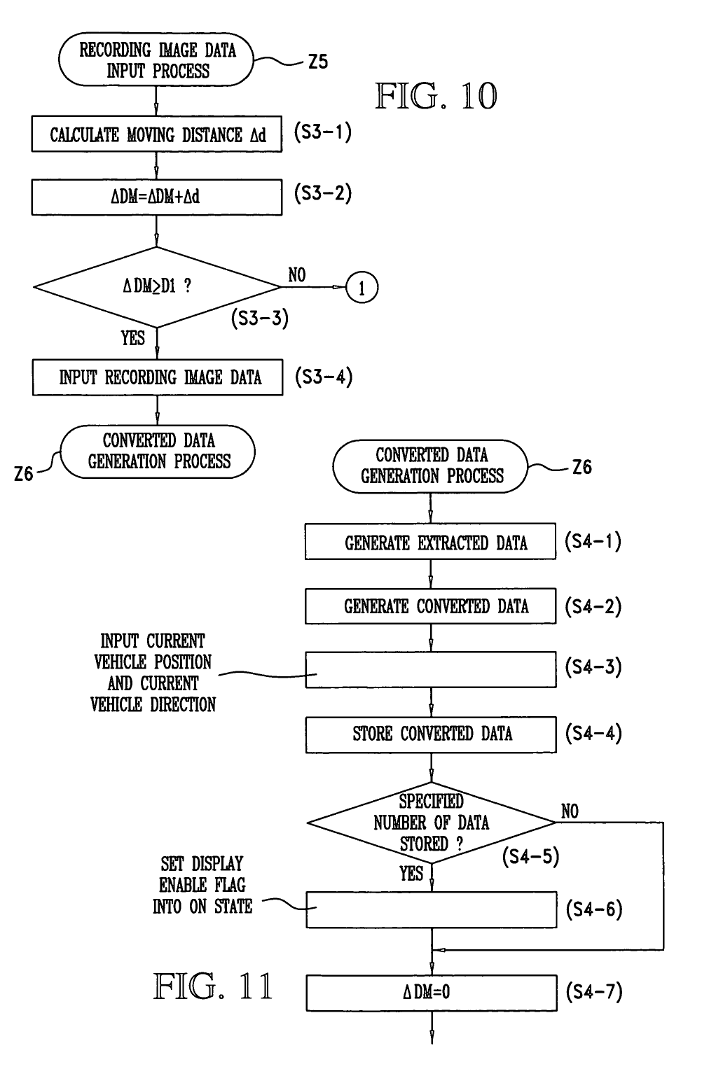

The recording data input subroutine is as illustrate in FIG. 10. The controller 3 calculates the moving distance Δd from the reference position based on the vehicle speed pulse VP input via the vehicle interface 13 (step S3-1). Here, the reference position is the position of the vehicle C as of the previous calculation of the moving distance Δd in step S3-1.

The controller adds the moving distance Δd calculated in step S3-1 to the distance ΔDM of reverse movement (step S3-2). The controller 3 then determines whether the updated reverse movement distance ΔDM is equal to or greater than the image recording distance D1 (200 mm) (step S3-3). If the reverse movement distance ΔDM has not yet reached the image recording distance D1 (that is, if the answer to step S3-3 is No), the routine returns to step 2-1 to repeat the above-described process.

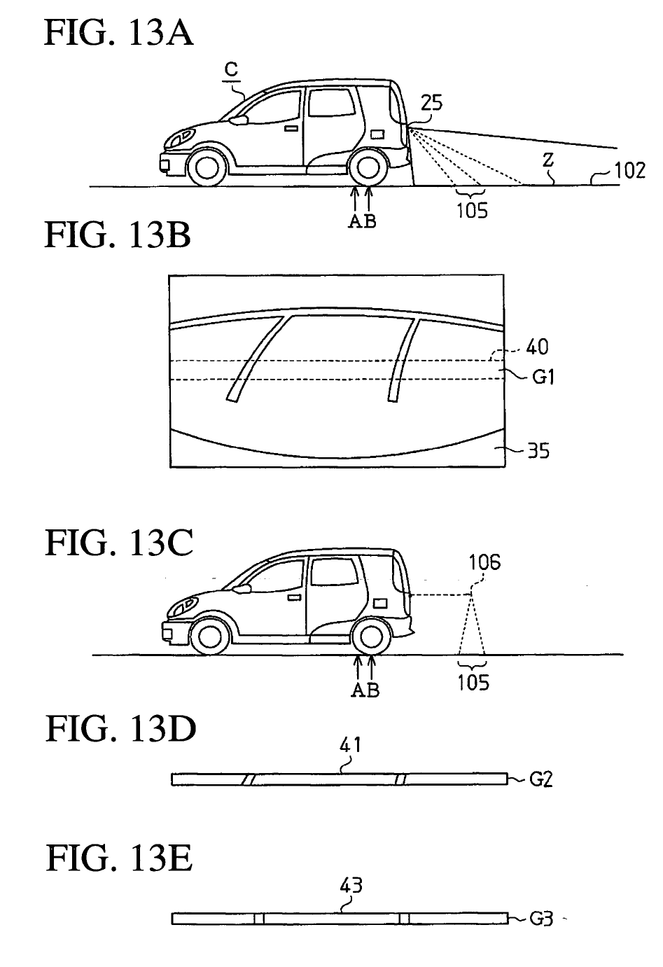

For example, in the case in which, as shown in FIG. 13A, the vehicle C is currently at a position B after the vehicle C has moved rearward by the image recording distance D1 from the initial position A, the rearward moving distance ΔDM is equal to the image recording distance D1 (and thus the answer to step S3-3 is Yes), and thus, under the control of the controller 3, the image processing unit 16 acquires the image data G for an image taken at the position B (step S3-4). If the recording image data G for an image taken at a position other than the initial position A is acquired, the image processing unit 16 executes the converted data generation subroutine.

Converted Data Generation Subroutine

The converted data generation subroutine is shown in FIG. 11. Under the control of the controller 3, the image processing unit 16 generates extracted data G1 by extracting data for an area 40, such as that shown in FIG. 13B, from the image data G for an image taken at a position B (step S4-1). Thereafter, as shown in FIG. 13C, the image processing unit 16 converts the extracted data G1 into data representing an image viewed from a virtual viewpoint 106 defined for a point vertically above an area 105 (corresponding to the extracted area 40) of road surface 102. Thus, converted data G2 representing an image 41 such as that shown in FIG. 13D is generated from a central portion of the extracted data G1 (step S4-2).

The image processing unit 16 receives, from the controller 3, data indicating the position (B) and the direction GR of the vehicle when the image represented by the converted data G2 was taken (step S4-3). The received data indicating the position and the direction GR is attached as image taking position data 17 and direction data 18 to the converted data G2 and stored in the image memory 15 (step S4-4).

The controller 3 then determines whether at least as many sets of converted data G2 as specified (nine frames or images, in the present embodiment) are stored in the image memory 15 (step S4-5). As of when the converted data G2 for the position B is generated, two frames of converted data G2, one of which was generated at the initial position A and the other one at the position B, are stored in the image memory 15, and thus it is determined that as many frames of converted data G2 as specified are not stored in the image memory 15 (that is, the answer to step S4-5 is No). In this case, the subroutine returns to step S4-7. In step S4-7, the controller 3 initializes the distance of rearward movement ΔDM to “0”. After initialization of the distance of rearward movement ΔDM, the controller 3 determines whether an end trigger has been output (step S5). If no end trigger is found (that is, if the answer to step S5 is No), the subroutine returns to step S2-1.

As the vehicle C moves in reverse from the initial position A toward the target area 100 in which to park the vehicle C, one set of converted data G2 is generated and stored in the image memory 15 each time the vehicle C moves an image recording distance D1. If the number of sets of data stored in the image memory 15 reaches the predetermined number (24 data), after the vehicle C has moved a predetermined distance from the initial position A, the controller 3 determines in step S4-5 that as many sets of converted data G2 as required are stored in the image memory 15, and the controller 3 sets a display enable flag to ON (“1”) (step S4-6). The display enable flag is a flag indicating whether as many sets of converted data G2 as required are stored.

In the process of moving the vehicle C in reverse from the initial position A toward the target parking space 100, when the vehicle position reaches a final parking position L as shown in FIG. 5 or when the driver decides to restart the parking operation, the driver shifts from the reverse position to the drive position or parking position. In this case, in step S2-2, the controller 3 determines that the shift position SP has been switched from the reverse position to another position.

Thereafter, as described above, the controller 3 determines whether the system start flag FS is ON (step S2-11). When the vehicle has reached the final parking position L or immediately after the driver decides to restart the parking operation, the system start flag FS is ON (that is, the answer to step S2-11 is Yes), and thus the process proceeds to step S2-12.

In step S2-12, the controller 3 determines whether the display enable flag is ON. When the vehicle C is at the final parking position L after the movement from the initial position A, as many sets (frames) of converted data G2 as required (24 frames) are stored, and thus the controller 3 determines that the display enable flag is ON (that is, the answer to step S2-12 is Yes) and the controller 3 executes the bird's eye image display subroutine (step S2-13).

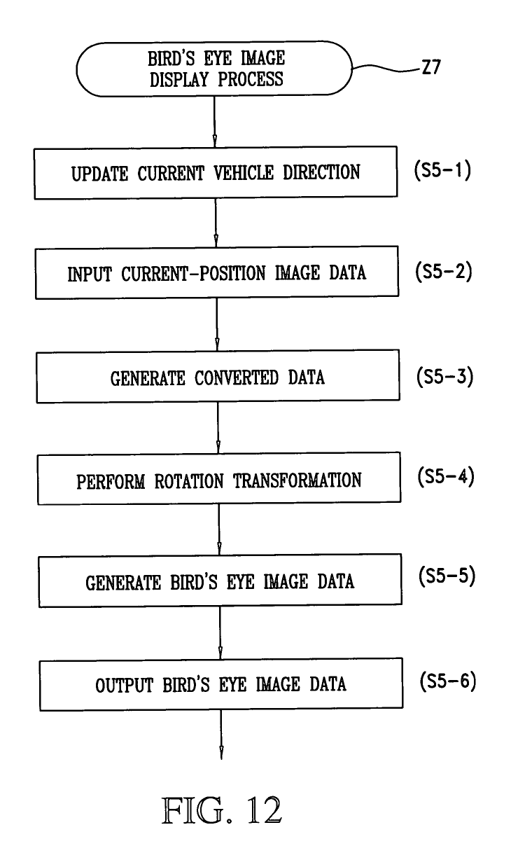

In the bird's eye image display subroutine, as shown in FIG. 12, the controller 3 acquires the direction detection signal GRP via the vehicle interface 13 and updates the current direction GR (step S5-1). The image processing unit 16 then acquires, via the image data input unit 14, image data G for an image taken at the current position of the vehicle C (hereinafter referred to as current-position image data GP) (step S5-2).

The image processing unit 16 extracts data for the extraction area from the current-position image data GP and executes viewpoint conversion of the extracted data to obtain converted data GP2 representing a view from the virtual viewpoint (step S5-3). Note that the virtual viewpoint used in the viewpoint conversion process is set at a point vertically above an area of the road surface 102 corresponding to the extracted data.

In accordance with the updated current direction GR, the image processing unit 16 rotates the respective sets of converted data G2 thereby generating rotated data G3 (step S5-4). More particularly, the image processing unit 16 extracts, from the converted data G2 stored in the image memory 15, 24 sets (frames) of converted data G2 corresponding to positions closest to the current position of the vehicle C, i.e. sets of converted data G2 derived from images taken within a predetermined distance from the current position of the vehicle C. The image processing unit 16 calculates the relative angle between the direction data 18 attached to each of the respective sets of converted data G2 and the current direction GR of the vehicle. The image processing unit 16 then reads, from the ROM 5, a conversion table corresponding to the relative angle calculated for each set of converted data G2. The ROM 5 stores conversion tables for the respective relative angles. The conversion tables may be based on a known coordinate transformation technique such as the affine transformation.

The image processing unit 16 then maps the pixel values at respective coordinates of the converted data G2 as coordinates specified by the conversion table. As a result of the image rotation process described above, the respective sets of the converted data G2 for images taken by the camera 25 at particular angles, varying from one set to another, are converted into data representing images viewed from the current viewpoint of the camera 25, to obtain rotated data G3. For example, the sets of converted data G2 captured at the initial position A and at the position B are respectively converted into a rotated image 42 as shown in FIG. 6E and a rotated image 43 as shown in FIG. 13E.

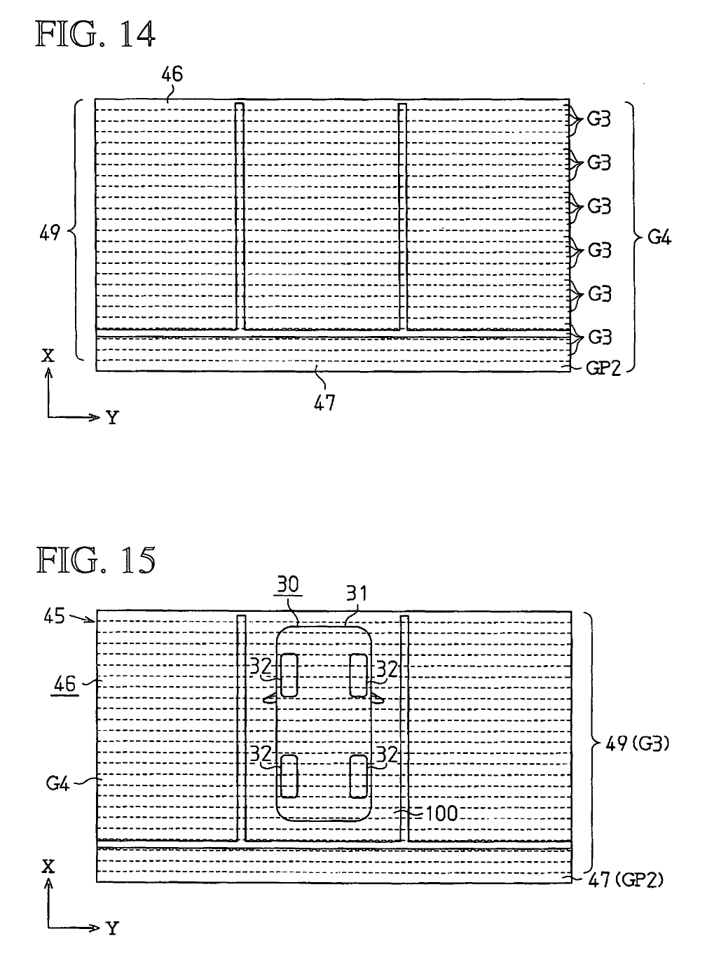

Thereafter, the image processing unit 16 generates bird's eye view data G4 by combining the converted data GP2 based on the current-position image data GP and the respective rotated data G3 to arrange that data side by side with adjacent data sets connected at their edges. (step S5-5). In the present embodiment, sets of rotated data G2 are placed side by side in the x direction corresponding to the direction of the movement of the vehicle C. More specifically, the current-position image data GP is placed at the bottom of the display area 8z of the display 8, and sets of the rotated data G3 are placed side by side in an area above the current-position image data GP. The rotated data G3 captured at a position farthest from the current position of the vehicle C (that is, the oldest of this data) is placed at the top in the display area 8z. In other words, rotated data G3 corresponding to respective positions in a direction forward from the current position of the vehicle C are successively placed in the display area 8z in a direction from bottom to top of the display area 8z. As a result, bird's eye view data G4 representing a bird's eye image 46, such as that shown in FIG. 14, is obtained. The bird's eye view data G4 is composed of the current-position image data GP and 24 sets of rotated converted-data G3, captured every 200 mm during the movement of the vehicle C, and the bird's eye view data G4 represents an area with a length nearly equal to the length of the vehicle C.

The image processing unit 16 displays a screen based on the resultant bird's eye view data G4 on the display monitor 8 (step S5-6). Furthermore, in accordance with the current vehicle position data given by the controller 3, the image processing unit 16 displays the vehicle contour 30 on the bird's eye view. As a result, as shown in FIG. 15, a parking position confirmation screen 45 is displayed on the display monitor 8.

In this bird's eye image 46, a component corresponding to the current-position image 47 based on the converted data GP2 captured at the current vehicle position is displayed at the bottom, in the x direction, of the display area 8z. Portions corresponding to previous-position image 49 based on the rotated data G3 are displayed in an upper area of the display area 8z such that the travel direction of the vehicle C can be correctly understood from the displayed bird's eye image 46. That is, because the parking position confirmation screen 45 is displayed when the shift position is switched from the reverse position to the drive position, the travel direction of the vehicle C becomes the forward direction. The driver understands that the direction (positive x direction) from the bottom to the top of the display screen indicates the travel direction of the vehicle C. Therefore, the bird's eye image 46 should be formed such that the direction from the bottom to the top of the bird's eye image 46 coincides with the direction of travel of the vehicle C so as to be easily understood by the driver.

As described above, the vehicle contour 30 indicating the current vehicle position is superimposed on the bird's eye image 46. This makes it possible for the driver to see the position in which the vehicle C is parked. That is, from the position of the vehicle contour 30 relative to the target parking space 100 included in the bird's eye image 46, the driver can determine whether the vehicle C is in a correct position and oriented in the correct direction in the target parking space 100.

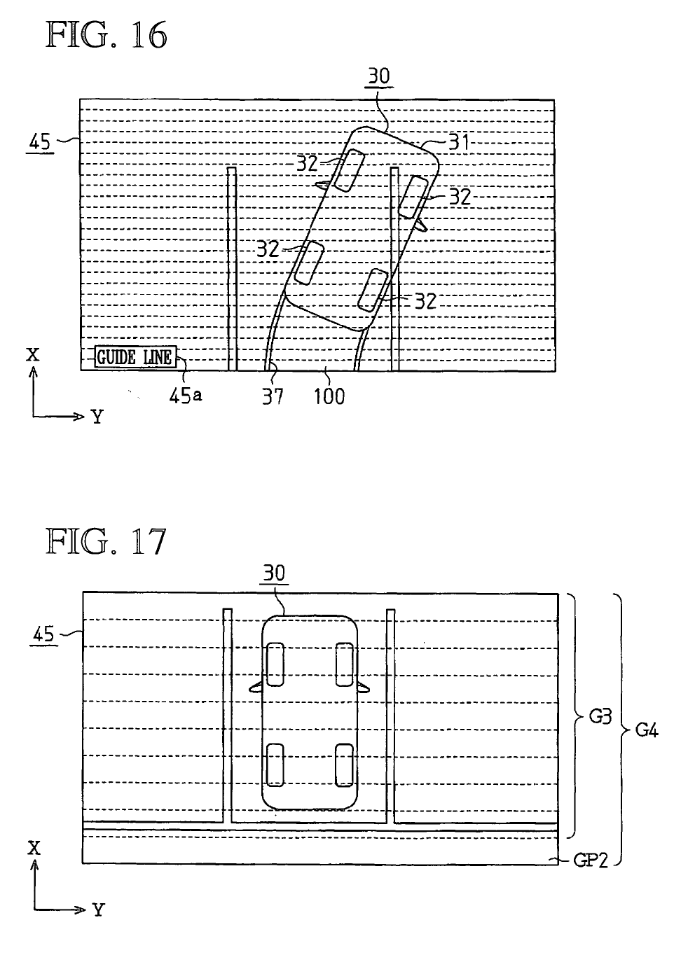

When the driver decides to restart the parking operation before completion, a parking position confirmation screen 45 such as that shown in FIG. 16 allows the driver to understand the position of the vehicle relative to the target parking area 100 and to determine the correct distance the driver should drive the vehicle forward and the correct rudder angle at which the steering wheel should be set. In response to operation of an icon 45a displayed on the parking position confirmation screen 45 shown in FIG. 16, predicted locus lines 37 or the like may be displayed.

The image processing unit 16 continuously displays the parking position confirmation screen 45 for a predetermined period (for example, 10 seconds) or until the operation switch 9 is pressed. If the bird's eye image display subroutine is completed, the process returns to step S2-14. In step S2-14, the parking position confirmation screen 45 is replaced by another screen such as the map screen 8a. The controller 3 then resets the respective variable items of data to their initial values (step S2-15) and resets the system start flag FS to the OFF state (step S2-16). Thereafter, the process returns to step S2-1.

If it is determined that the shift position SP is not the reverse position (that is, if the answer in step S2-2 is No) and if it is further determined that the system start flag SF is OFF (that is, if the answer in step S2-11 is No), then the controller 3 determines whether an end trigger has been input to the controller 3 in response to, for example, turning-off of the ignition (step S5). If, while the parking position confirmation screen 45 is displayed, the driver decides to redo the parking operation (that is, when the answer in step S5 is No), no end trigger is received, and thus the routine returns to step S2-1 to repeat the above-described process. On the other hand, in the case in which the parking operation is completed and the end trigger is input to the controller 3 (that is, when the answer in step S5 is Yes), the process is immediately ended.

The above-described embodiments of the present invention provide the following advantages.

(1) Because the parking position confirmation screen 45 is displayed when the parking operation is completed, the driver can determine whether the vehicle has been parked correctly at the correct position and in the correct direction with respect to the target parking space 100, without need to exit the vehicle for confirmation. Thus, the navigation apparatus 1 is useful not only for drivers who view the rear view monitor screen during the parking operation but even for drivers who do not view the display monitor 8 during the parking operation.

(2) In the embodiments described above, the image processing unit 16 generates the bird's eye view data G4 by arranging a plurality of successive sets of rotated data G3 side by side in the direction corresponding to the travel direction of the vehicle C, utilizing a simple combining process in which converted data G2 for images obtained at respective positions during the reverse movement of the vehicle C toward the target parking area 100 are combined.

(3) In the embodiments described above, the image processing unit 16 generates the bird's eye view data G4 so that its part corresponding to a forward area as viewed from the vehicle C is displayed at the top of the display area 8zof the display 8. The bird's eye image 46 is based on the generated bird's eye view data G4 obtained at the time at which the direction of movement of the vehicle C is changed by switching the shift position SP from reverse to another position. Thus, the bird's eye image 46 is displayed such that the direction of the bird's eye image 46 is coincident with the direction of movement (forward direction) of the vehicle C so that the driver can easily understand the correct direction.

(4) In the embodiments described above, the image processing unit 16 generates the bird's eye view data G4 from the converted data G2 so as to represent an area including the whole vehicle C at the present position. That is, the displayed bird's eye image 46 represents an area of the road surface 102 including the whole vehicle C which allows the driver to easily understand the relative position and the relative direction of the vehicle as a whole with respect to the target parking space 100.

(5) In the embodiments described above, the virtual viewpoint 104 or 106 is set at a height equal to the height of the camera vertically above the zone 103 or 105 of the road surface 102 corresponding to the extraction area 40 of the image data G. This allows bird's eye images 49 of zones 103 or 105 of the road surface 102 to be obtained at successive positions. Thus, the bird's eye view generated by smoothly connecting respective images 49 is displayed on the display 8 in an easy-to-understand manner.

(6) In the embodiments described above, because the area of the image data G from which the extracted data G1 is taken, is the extraction area 40 in the middle of the image data G, even when the original data G has distortion in its peripheral area due to the wide angle lens of the camera 25, the extracted data does not have great distortion because it is extracted from the middle area which has little distortion. Thus, the composite image produced by combining a plurality of sets of extracted data has little distortion. Moreover, because the extraction area 40 corresponds to an area of the road surface. relatively close to the vehicle C, a clear image can be obtained as the resultant composite image for use as the parking position confirmation screen 45.

(7) Because the image processing unit 16 acquires image data G for images successively captured at each image taking position and stores the acquired data in the form of converted data G2 in the image memory 15, using this converted data G2 already stored in the image memory 15, it is possible to output the bird's eye view data G4 immediately when the shift position SP is switched.

(8) In the embodiments described above, because the parking assist apparatus is incorporated into navigation apparatus 1, including the display 8 and the vehicle interface 13, effective use is made of various parts of the navigation apparatus 1. Further, because the converted data G2 is stored together with high-precision image taking position data 17 attached thereto (correlated with) in the image memory 15, the bird's eye image 46 can be generated by smoothly connecting a plurality of sets of converted data G2.

The embodiments described above may be modified, for example, as follows.

In the embodiments described above, the rear view screen 33 is displayed when the shift position is the reverse position. Alternatively, a composite screen using image data G from images taken at various positions may be displayed. The composite screen displayed in this modification may be a screen obtained as a result of image processing of the current-position image data GP or may be a screen produced by combining image data G from images captured at various positions and the current-position image data GP. For example, as shown in FIG. 22, a composite bird's eye view screen 50 representing a bird's eye view image of the rear end of the vehicle C and a nearby area behind the vehicle C may be displayed. The composite bird's eye view screen 50 may be produced by the image processing unit 16 or the like by smoothly connecting respective images 51 based on converted data G2 derived from images captured at various positions and a current-position image 52 based on the current-position image data GP. For example, as described above, the converted data G2 is obtained by extracting image data G captured at various positions in a particular area corresponding to a length of 200 mm on a road surface and converting the extracted image data G into a bird's eye view image. The converted data G2 is stored in the image memory 15. If the image processing unit 16 receives a trigger signal indicating the timing for display of the composite bird's eye view screen 50, the image processing unit 16 reads a predetermined number of sets (shots) (for example, five sets) of converted data G2 representing the rear end of the vehicle C at the current position and a nearby area behind the vehicle C, in accordance with the image taking position data 17 correlated with (attached to) the converted data G2. The image processing unit 16 then rotates each set of read converted data G2 in accordance with the current direction or the rudder angle indicated by the direction data 18. Furthermore, the image processing unit 76 extracts a portion of the image data GP for a range of several meters (for example, 4 meters) closest to the vehicle and smoothly connects the extracted portion of the image data GP and the respective sets of converted data G2 thereby producing image output data. Thus, the resultant composite bird's eye view screen 50 has a greater percentage of the current-position image 52 as compared with the parking position confirmation screen 45.

On the other hand, in the resultant composite bird's eye view screen 50, an image of a range of about 1 m of the road surface is based on the previous-position image 51 according to the converted data G2 which range corresponds to the current blind spot of the camera 25. Also note that the current-position image 52 based on the image data GP represents the current state of the vicinity (nearby area) behind the vehicle. Thus, when a moving body such as a pedestrian or a bicycle enters the nearby area behind the vehicle and the moving body is captured within capturing range Z by the camera 25, the moving body 54 is displayed so as to be included in the current-position image 52, as represented by a broken line in the figure. On the composite bird's eye view screen 50, even white lines or the like currently located in the blind spot of the camera 25, as a result of the rearward movement of the vehicle C, are displayed using the previous-position image 51. This makes it possible for the driver of the vehicle to perform the parking operation while checking whether the vehicle is correctly moving toward the target parking space. Compared with the parking position confirmation screen 45 displayed when the parking operation is completed, the composite bird's eye view screen 50 has a greater percentage of the current-position image 52 (current-position image data GP), which allows it to detect an obstacle behind the vehicle over a greater area than is allowed by the parking position confirmation screen 45. The composite bird's eye view screen 50, displayed when the shift position SP is in reverse, is switched to the parking position confirmation screen 45 when the shift position SP is switched from the reverse position to any other position. In this switching operation, because the composite bird's eye view screen 50 is switched to the same screen as the parking position confirmation screen 45 that is displayed when the parking operation is completed, the driver should be comfortable with the switching of the screens.

Alternatively, when the parking position confirmation screen 45 is displayed, if a moving object enters an area nearby the vehicle C, one of the composite bird's eye view screen 50, another composite screen, and the rear view monitor screen 33 may be displayed. For example, as shown in FIG. 23, a sensor 55 such as a radar or a sonar may be installed at least on the rear end of the vehicle C to detect an obstacle present to the rear (or to the front when the vehicle is moving forward) whereby an obstacle is detected, the sensor 55 (or the controller 3) measures the relative distance to the detected obstacle and outputs the measured relative distance to the controller 3 serving as moving body detection means. The controller 3 samples the relative distance output from the sensor 55 at predetermined sampling intervals to monitor a change in the relative distance. If a change in the relative distance between the vehicle C and the obstacle is detected, the controller 3 determines that the obstacle is a moving body such as a pedestrian. If it is determined that there is a moving body 54 to the rear (or to the front) of the vehicle C, the controller 3 controls the image processing unit 16 and the image output unit 19, which serve as the image switching means, so as to switch the screen displayed on the display monitor 8 from the parking position confirmation screen 45 to one of the composite bird's eye view screen 50, another composite screen, and the rear view monitor screen 33. Thus, when the moving body 54 enters an area nearby the vehicle, an image is displayed on the display monitor 8 to show the current nearby area and to call the driver's attention to the moving body. When the moving body 54 is within the current capturing range Z of the camera 25, the moving body 54 is displayed on the composite bird's eye view screen 50 to allow the driver to recognize the position of the moving body 54. In this case, when the moving body 54 enters the area nearby the vehicle, a message or like may be displayed on the composite bird's eye view screen 50 or an alarm may be output from the speaker 12 to inform the driver of the detection of an incoming moving body.

In the embodiments described above, the controller 3 acquires the shift position signal SPP from the neutral start switch 22 via the vehicle interface 13. Alternatively, the shift position signal SPP may be acquired from a transmission ECU or other device, or the controller 3 may determine whether the shift position SP is the reverse position based on the vehicle speed pulse VP.

The vehicle contour 30 may be in the form of a rectangle so as to indicate the size of the vehicle C, or the vehicle contour 30 may be in other forms. Another mark may be added to the vehicle contour 30 to indicate the front or rear side of the vehicle.

In the embodiments described above, stopping of the parking operation is defined as a change of the shift position SP from the reverse position to another position, whereupon the bird's eye image display subroutine is executed. Alternatively, that the parking operation is stopped may be defined differently. For example, the state in which the parking operation is stopped may be defined as a state in which output of the vehicle speed pulse is stopped. Alternatively, when the vehicle C is moving in reverse, if a signal indicating that brakes of the vehicle C have been applied is received from an antilock brake system (ABS) of the vehicle C, and if the signal has been continuous for a predetermined period, or if the vehicle speed pulse VP indicates that the vehicle C has been stopped for a predetermined period, the vehicle C may be regarded as being in the state in which the parking operation has been stopped. The bird's eye image display subroutine may be executed responsive to pressing an operation icon displayed on the display monitor 8 while the vehicle is in the state in which the parking operation is stopped. Alternatively, if a parking line (white line) detection system provided in the navigation apparatus 1 or in another on-board apparatus indicates that the vehicle C is completely within a parking space, the parking operation may be regarded as stopped. Alternatively, when the vehicle C has reached a position specified in advance by the driver or any other person, the parking operation may be regarded as stopped.

In the embodiments described above, the image processing unit 16 generates the converted data G2 using a middle portion of the extracted data G1. Alternatively, the converted data G2 may be generated using the whole of the extracted data G1 and, when the bird's eye view data G4 is generated, only the middle portion of the rotated data G3 may be used.

In the embodiments described above, the converted data G2 corresponding to a zone with a width of 200 mm of a road surface is generated using the middle portion of the extracted data G1 corresponding to a zone 103 or 105 with a width of 500 mm of the road surface. Alternatively, the image processing unit 16 may generate the extracted data G1 by extracting a portion, corresponding to a zone of road surface with a width of 200 mm, from the image data G (and may use the entirety of the extracted data G to generate the bird's eye image 46).

Although in the embodiments described above, the image recording distance D1 is set at 200 mm, the image recording distance D1 may be set at a different value. For example, the image recording distance D1 may be set at a value smaller than 200 mm, such as 80 mm, or to a value greater than 200 mm, such as 300 mm.

In the embodiments described above, the extraction zone 40 is defined so as to correspond to a zone 103 or 105 in the road surface with a width of 500 mm, and the extracted data G1 is generated by extracting the data for the extraction zone 40 from the image data G. Alternatively, the width of the extraction zone 40 may be set greater or smaller than 500 mm. For example, as shown in FIG. 17, the parking position confirmation screen 45 may be divided into ten zones, and the parking position confirmation screen 45 may be generated using nine sets of rotated data G3 and the current-position image data GP. In this case, the image recording distance D1 may be set, not to 200 mm, but to a rather large distance such as 500 mm. Conversely, The parking position confirmation screen 45 may be divided into 25 or more zones, and the parking position confirmation screen 45 may be generated using 19 or more sets of rotation converted-data G3.

In the embodiments described above, the bird's eye view data G4 is generated using only a plurality of sets of converted data G2 without using the current-position image data GP, and the parking position confirmation screen 45, without a current-position image 47, may be displayed on the display monitor 8. For example, when the image recording distance D1 is set to be relatively small, the bird's eye image 46 can include the whole area of the vehicle C without using the current-position image data GP.

In the embodiments described above, each time the vehicle C moves the image recording distance D1, image data G is captured and the extracted data G1 and the converted data G2 are generated. Alternatively, as many sets of extracted data G1 and converted data G2 as required may be generated at the same time using stored image data G, for example, when the shift position SP is switched from reverse to another position. In this case, for example, the image taking position data 17 and the direction data 18 may be attached to (correlated with) the image data G acquired via the image data input unit 14, and the image data G may be stored as the recorded image data together with the attached data in the image memory 15. When the shift position SP is switched from reverse to another position, and thus the parking operation is treated as stopped, the image processing unit 16 may read a necessary number of sets of image data G and may generate the extracted data G1, the converted data G2, and the rotated data at the same time.

In the embodiments described above, the image processing unit 16 generates the extracted data G1 from the image data G and converts the viewpoint of the extracted data G1. Alternatively, the viewpoint of the image data G may be converted first, and then data G1 extracted.

In the embodiments described above, the virtual viewpoint 104 is set at a height equal to the height of the camera 25 vertically above the zone 103 or 105 of the road surface corresponding to the extraction area 40. However, the virtual viewpoint 104 may be set at another point such as a point higher than the roof of the vehicle C.

In the embodiments described above, when the shift position SP is at a position other than reverse and the display enable flag is in the ON state, the converted data G2 is rotated in accordance with the direction GR at that time. Alternatively, the rotation may be in another direction. For example, the position and the direction of the target parking space 100 may be detected by the navigation apparatus 1, and the converted data G2 may be rotated in accordance with the detected direction of the target parking space 100. The direction of the target parking space 100 may be manually set by the driver via an icon (button) displayed on the display monitor 8, or may be detected using a parking line (white line) detection system provided in the navigation apparatus 1.

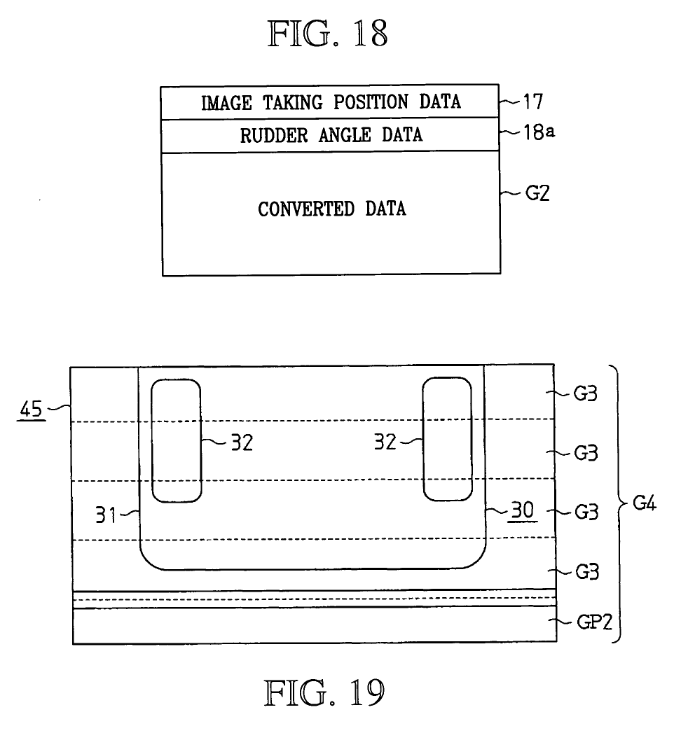

In. the embodiments described above, the direction data 18, according to which the converted data G1 is rotated, is attached to the converted data G2. Alternatively, as shown in FIG. 18, the rudder angle data 18a may be attached. In this case, the converted data G2 may be rotated according to the angle of the rudder angle data 18a attached to each set of converted data G2, relative to the rudder angle as of when the navigation apparatus 1 determines that the parking operation is completed or that the parking operation is temporarily stopped.

In the embodiments described above, the respective sets of converted data G2 are arranged so that the front part of the vehicle C is shown in an upper area of the display 8z. Alternatively, the converted data G2 may be arranged such that the front part of the vehicle C is shown in a lower area of the display 8z. For example, when the vehicle C is driven in the forward direction into a target parking space, the front part of the vehicle C is shown at a lower area of the display 8z, and the rear part of the vehicle C is shown at an upper area of the display 8z.

In the embodiments described above, the bird's eye view data G4 is generated using nine sets of converted data G2 corresponding to positions closest to the current position of the vehicle C. Alternatively, the nine sets of converted data G2 which were most recently stored may be used.

In the embodiments described above, the parking position confirmation screen 45 includes the whole vehicle. Alternatively, the parking position confirmation screen 45 may include only a portion of the vehicle. For example, as shown in FIG. 19, the bird's eye view data G4 may be formed from rotated data G3 corresponding to a rear portion of the vehicle C in combination with the current-position image data GP. In this case, an arbitrary number of sets of converted data G2 may be used as required and the screen which is displayed when the parking operation is not stopped, e.g. when the vehicle C is moving backward, includes a greater percentage of an image based on the current-position image data GP than included in the parking position confirmation screen 45 shown in FIG. 19, as the rear view monitor screen 33.

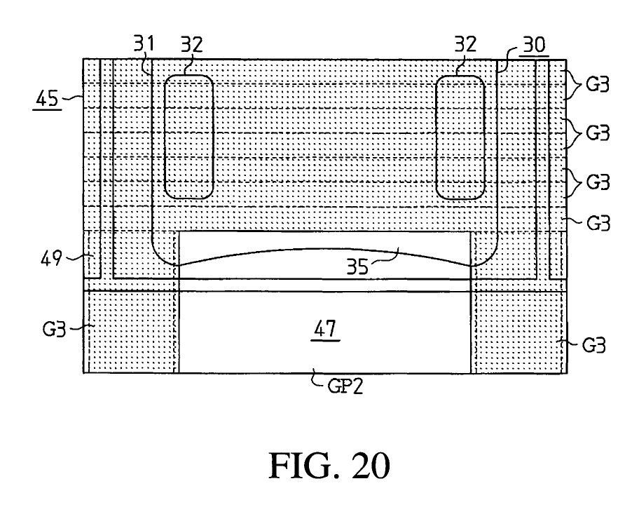

In the embodiments described above, a greater area may be extracted from the current-position image data GP, and the current-position image 47 based on the current-position image data GP may be displayed in a greater area as shown in FIG. 20. In this case, the extracted area of the current-position image data GP may include an image 35 of the rear bumper RB. In this case, areas corresponding to end portions BC of the rear bumper RB may be blind spots that cannot be covered by the camera 25 at the current position. Image data for such blind sports may be extracted from the image data G taken at the position closest to the current position of the vehicle C, and may be used to generate the converted data G2. In this case, the screen, which is displayed when the parking operation is not stopped, as when the vehicle C is moving backward, includes a greater percentage of an image based on the current-position image data GP than does the parking position confirmation screen 45 shown in FIG. 20.

In the embodiments described above, as shown in FIG. 20, the previous-position image 49 based on the rotated data G3 may be displayed in a manner that allows the previous-position image 49 to be distinguished from the current-position image 47. For example, at least one of properties including the color, the pattern, and the lightness of the rotated data G3 may be selected so as to be different from that of the current-position image data GP.

In the embodiments described above, an operation mode in which the parking position confirmation screen 45 is displayed when the parking operation is stopped may be enabled when a particular operation icon on the touch panel or the operation switch (button) 9 is pressed by a user.

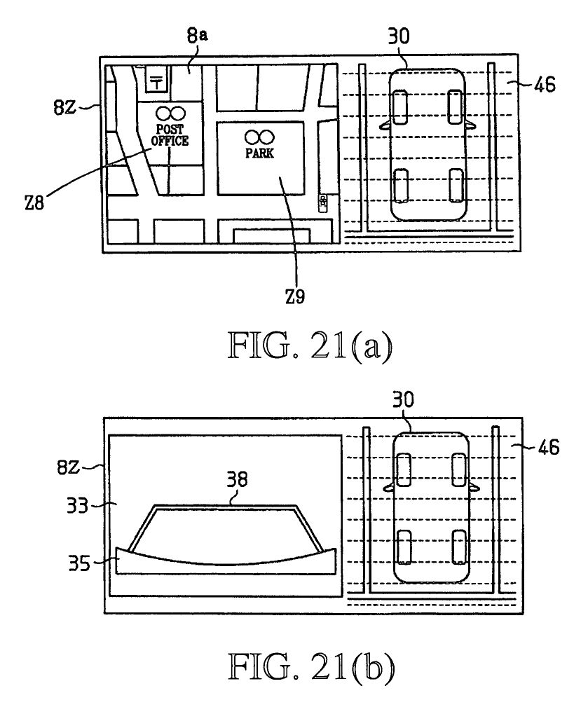

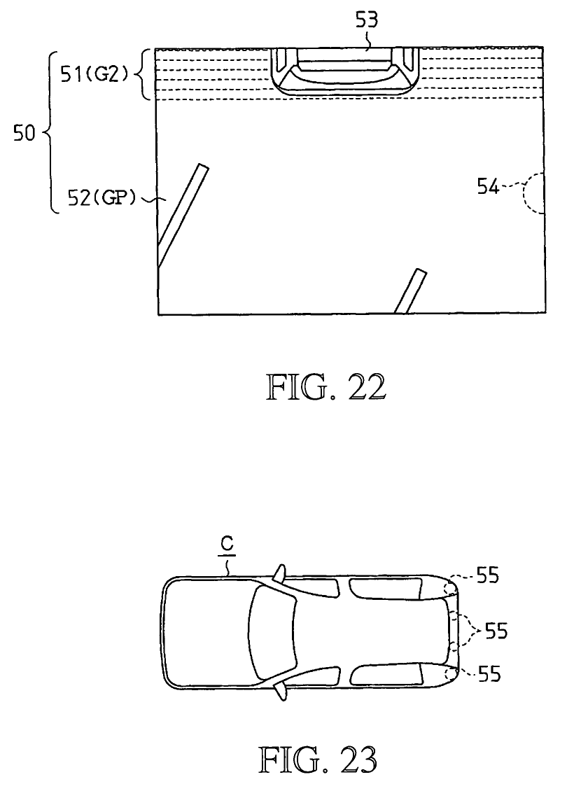

In the embodiments described above, the bird's eye image 46 extends over the entire display area 8z of the display monitor 8. Alternatively, the bird's eye image 46 may be limited to a portion of the display area 8z. For example, as shown in FIG. 21A, the bird's eye image 46 may be displayed in one half of the display area 8z, and the map screen 8a may be displayed in the other half. Alternatively, as shown in FIG. 21B, the bird's eye image 46 may be displayed in one half of the display area 8z, and the rear view monitor screen 33 may be displayed in the other half.

In the embodiments described above, when the shift position SP is changed from reverse to another position to restart or adjust the parking operation, the converted data G2 stored in the image memory 15 may be deleted. Alternatively, after the shift position SP is changed from reverse to the drive position, if the shift position SP is changed again to the reverse position, the converted data G2 stored in the image memory 15 may be reused. In this case, the coordinate transformation may be performed on the converted data G2 according to the image taking position data 17 and the direction data 18 attached to the converted data G2 and according to the angle of the camera 25.

In the embodiments described above, when the shift position SP is the reverse position, the rear view monitor screen 33 is displayed. Alternatively, a composite screen using image data G taken at various positions may be displayed.

In the embodiments described above, the camera 25 may be installed on a front end of the vehicle C, such as an upper front end of a front bumper, instead of installation on the rear end of the vehicle C. In this case, when the vehicle C moves forward toward the target parking space 100, image data G is acquired at each increment of movement of image recording distance D1, and the bird's eye view data G4 is generated from the acquired image data G. When the controller 3 determines that the parking operation is stopped, based on the detection of parking lines or based on the operation of the touch panel, the parking position confirmation screen 45 is displayed.

In the embodiments described above, the navigation apparatus 1 may include a gyroscopic sensor for detecting the direction of the vehicle C.

Although in the embodiments described above, the parking assist apparatus is embodied by the navigation apparatus 1, the parking assist apparatus may be incorporated into another on-board apparatus.

The invention may be embodied in other specific forms without departing from the spirit or essential. characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A method of assisting a vehicle parking operation, comprising:
acquiring image data from a camera unit installed in the vehicle;
storing the acquired image data in image storage means;
generating bird's eye view data representing an image of a nearby area around a current vehicle position in the form of a bird's-eye view based on the image data stored in the image data storage means when the vehicle parking operation is stopped; and
displaying the bird's eye view with a vehicle mark indicating the current vehicle position superimposed on the bird's eye view, on the display screen.

2. A parking assist apparatus for installation in a vehicle, comprising:
vehicle status determination means for determining whether a vehicle parking operation is stopped, based on vehicle information input to the vehicle status determination means;
image data acquisition means for acquiring image data from a camera unit installed in the vehicle;
first image processing means for generating converted data by image processing of the acquired image data;
image data storage means for storing the converted data;
second image processing means for generating bird's eye view data representing an image of a nearby area around a current vehicle position in the form of a bird's-eye view, based on the converted data stored in the image data storage means; and
image output means for, when the determination made by the vehicle status determination means is that the vehicle parking operation is stopped, displaying the bird's eye view, with a vehicle mark indicating the current vehicle position superimposed on the bird's eye view, on a display screen.

3. A parking assist apparatus for installation in a vehicle, comprising:
vehicle status determination means for determining whether a vehicle parking operation is stopped, based on vehicle information input to the vehicle status determination means;
image data acquisition means for acquiring image data from a camera unit installed in the vehicle;
image data storage means for storing the acquired image data;
first image processing means for generating converted data by image processing of the acquired image data;
second image processing means for generating bird's eye view data representing an image of a nearby area around a current vehicle position in the form of a bird's-eye view, based on the converted data; and
image output means for, when the determination made by the vehicle status determination means is that the vehicle parking operation is stopped, displaying the bird's eye view, with a vehicle mark indicating the current vehicle position superimposed on the bird's eye view, on a display screen.

4. The parking assist apparatus according to claim 3, wherein the image output means outputs the bird's eye view data such that an area on a front side thereof, as viewed forward in the direction of vehicle movement, is displayed in an area at the top of the display screen.

5. The parking assist apparatus according to claim 2, wherein the image output means outputs the bird's eye view data such that an area on a front side thereof, as viewed forward in the direction of vehicle movement, is displayed in an area at the top of the display screen.

6. The parking assist apparatus according to claim 2, wherein the vehicle status determination means determines, when the direction in which the vehicle is moving is changed from a direction toward a target parking space, that the vehicle parking operation is stopped.

7. The parking assist apparatus according to claim 3, wherein the vehicle status determination means determines, when the direction in which the vehicle is moving is changed from a direction toward a target parking space, that the vehicle parking operation is stopped.

8. The parking assist apparatus according to claim 2, wherein the vehicle status determination means determines, when the vehicle has not moved for a time longer than a predetermined period, that the vehicle parking operation is stopped.

9. The parking assist apparatus according to claim 3, wherein the vehicle status determination means determines, when the vehicle has not moved for a time longer than a predetermined period, that the vehicle parking operation is stopped.

10. The parking assist apparatus according to claim 2, wherein the second image processing means combines sets converted data, the sets derived from respective images taken by the camera unit, such that the converted data sets are arranged in a side-by-side series extending across the display screen in a direction corresponding to the direction of movement of the vehicle.

11. The parking assist apparatus according to claim 3, wherein the second image processing means combines sets converted data, the sets derived from respective images taken by the camera unit, such that the converted data sets are arranged in a side-by-side series extending across the display screen in a direction corresponding to the direction of movement of the vehicle.

12. The parking assist apparatus according to claim 2, wherein the second image processing means generates bird's eye view data representing an image of an area completely surrounding the vehicle, using a plurality of sets of converted data derived from respective images taken by the camera unit.

13. The parking assist apparatus according to claim 3, wherein the second image processing means generates bird's eye view data representing an image of an area completely surrounding the vehicle, using a plurality of sets of converted data derived from respective images taken by the camera unit.

14. The parking assist apparatus according to claim 2, wherein the first image processing means extracts a predetermined area from the acquired image data and converts the extracted data so as to represent an image of a road surface area corresponding to the extracted area, as viewed from a virtual viewpoint set as a point vertically above the road surface area.

15. The parking assist apparatus according to claim 3, wherein the first image processing means extracts a predetermined area from the acquired image data and converts the extracted data so as to represent an image of a road surface area corresponding to the extracted area, as viewed from a virtual viewpoint set as a point vertically above the road surface area.

16. The parking assist apparatus according to claim 2, wherein the second image processing means generates the bird's eye view data using (1) current-position image data acquired at the current vehicle position and (2) the stored converted data.

17. The parking assist apparatus according to claim 3, wherein the second image processing means generates the bird's eye view data using (1) current-position image data acquired at the current vehicle position and (2) the stored converted data.

18. The parking assist apparatus according to claim 2, wherein:
the image data storage means attaches, to the converted data or the acquired image data, direction data or rudder angle data indicating the direction or the rudder angle as of the time of generating the converted data or acquiring the image data; and
the image processing means rotates the converted data or the acquired image data in accordance with the attached direction data or rudder angle data and the direction or the rudder angle of the vehicle as of when the parking operation is stopped.

19. The parking assist apparatus according to claim 3, wherein
the image data storage means attaches, to the converted data or the acquired image data, direction data or rudder angle data indicating the direction or the rudder angle as of the time of generating the converted data or acquiring the image data; and
the image processing means rotates the converted data or the acquired image data in accordance with the attached direction data or rudder angle data and the direction or the rudder angle of the vehicle as of when the parking operation is stopped.

20. The parking assist apparatus according to claim 2, wherein the first image processing means extracts a middle area, as viewed in the direction of movement of the vehicle, from the acquired image data.

21. The parking assist apparatus according to claim 3, wherein the first image processing means extracts a middle area, as viewed in the direction of movement of the vehicle, from the acquired image data.

22. The parking assist apparatus according to claim 2, wherein the image data acquisition means acquires the image data from the camera unit and stores the acquired image data in the image data storage means each time the vehicle reaches one of plural positions predetermined for capture of image data.

23. The parking assist apparatus according to claim 3, wherein the image data acquisition means acquires the image data from the camera unit and stores the acquired image data in the image data storage means each time the vehicle reaches one of plural positions predetermined for capture of image data.

24. A parking assist apparatus installed in a vehicle, comprising:
vehicle status determination means for determining whether a vehicle parking operation is stopped, based on vehicle information input to the vehicle status determination means;
image data acquisition means for acquiring image data from a camera unit installed in the vehicle;
first image processing means for generating converted data by image processing of the acquired image data;
image data storage means for storing the converted data;
composite data generation means for generating composite data including data representing an image of a rear end portion of the vehicle and an image of a nearby area behind the vehicle, based on current-position image data acquired at the current vehicle position and the converted data which is stored in the image data storage means and which represents an image of an area in a current blind spot of the camera unit;
second image processing means for generating, using the converted data stored in the image data storage means, bird's eye view data which represents a bird's-eye view image of an area completely surrounding the vehicle at the present position and which includes a smaller percentage of the current-position image data than is included in the composite data; and
moving body detection means for detecting a moving body in an area nearby the current vehicle position;
image output means for outputting, responsive to a determination that the vehicle parking operation is stopped, a bird's eye view image including an image of the whole vehicle based on the bird's eye view data and a vehicle mark indicating the current vehicle position superimposed on the bird's eye view image, for display on a display screen; and
image switching means for switching image data, when the image based on the bird's eye view data and the vehicle mark are displayed on the display screen, responsive to detection of a moving body, to output the composite data to the display screen.
